(19) United States
(12) Patent Application Publication
(10) Pub. No.: US 2012/0110477 A1
(43) Pub. Date: May 3, 2012

(54) SYSTEMS AND METHODS FOR ENABLING VIRTUAL SOCIAL INTERACTIONS

(75) Inventor: Nicolas GAUME, Paris (FR)

(73) Assignee: Mimesis Republic, Paris (FR)

(21) Appl. No.: 12/938,033

(22) Filed: Nov. 2, 2010

(51) Int. Cl. G06F 3/048; G06F 15/16

(52) U.S. Cl. 715/757

(57) ABSTRACT

A system and methods that enables virtual social interactions for digital representations through the use of virtual objects. A digital representation may be a three-dimensional avatar or a two-dimensional image, and may be animated or static. A power item is received via a network, the power item being a virtual object that is associated with one or more predetermined virtual actions. The power item is stored in a memory medium that is accessible to a computing device. The power item is associated with a first digital representation which is displayed on a screen, the first digital representation being a representation of a first user in a network service. The power item is then triggered, and a second digital representation is transformed based upon the power item, the second digital representation being a representation of a second user in a network service.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates in general to the field of virtual social interactions for digital representations, and in particular to enabling avatar social interactions through the use of dedicated virtual objects.

### SUMMARY OF THE INVENTION

In an embodiment, a method provides social interactions for digital representations, including two-dimensional (2D) images, three-dimensional (3D) images, realistic computer graphic representations or avatars. Such representations may be static or animated. A power item may be received via a network, the power item being a virtual object that is associated with one or more predetermined virtual actions. A power item may be customized. The predetermined virtual actions may be expressed aurally and/or visually, including graphics and text. The power item is stored in a memory medium that is accessible to a computing device.

The power item is triggered by a first digital representation which is displayed on a screen, the first digital representation being a representation of a first user in a network service. The network service may be a virtual world, a social network service, an on-line game, an Internet webpage, a text message service, an instant messaging service, an online blog or an online posting service.

At least one digital representation is transformed based upon the power item. Such a transformed digital representation may include a set of transformed digital representations or just a second digital representation for a second user in a network service. For example, multiple second users, such as a group of target users for an action, may be included.

The power item may be associated with an icon in a graphical user interface (GUI). The power item may be selected and activated, whereby the power item may become associated with a digital representation. A trace based on the power item may be provided for a digital representation. The trace may also be based on contextual information in the network service. The trace may be visually represented a mark on a digital representation, a profile of a user of the network service, a network feed, or a virtual posting.

A triggered power item may spawn other digital representations, traces, notifications or virtual messages. Social patterns may be established between the digital representations, and virtual stories may be developed.

### BRIEF DESCRIPTION OF THE DRAWINGS

The foregoing and other objects, features, and advantages of the invention will be apparent from the following more particular description of embodiments as illustrated in the accompanying drawings, in which reference characters refer to the same parts throughout the various views. The drawings are not necessarily to scale, emphasis instead being placed upon illustrating principles of the invention.

FIG. 1 shows a screen shot illustrating a social interaction for digital representations, in accordance with certain embodiments of the invention.

FIG. 2 illustrates a virtual object generated by a program on a computer, in accordance with certain embodiments of the invention.

FIG. 3 shows icons for power items, in accordance with certain embodiments of the invention.

FIGS. 4 and 5 show screen shots illustrating virtual expressions of predetermined virtual actions of power items for avatars, in accordance with certain embodiments of the invention.

FIGS. 6(a)-(d) show traces for an avatar, in accordance with certain embodiments of the invention.

FIG. 7 shows a flow chart of the use of a power item, in accordance with certain embodiments of the invention.

FIG. 8 shows a flow chart of the contextual information used in expressing a predetermined virtual actions for a power item, in accordance with certain embodiments of the invention.

### DETAILED DESCRIPTION OF THE EMBODIMENTS

Reference will now be made in detail to the embodiments of the present invention, examples of which are illustrated in the accompanying drawings.

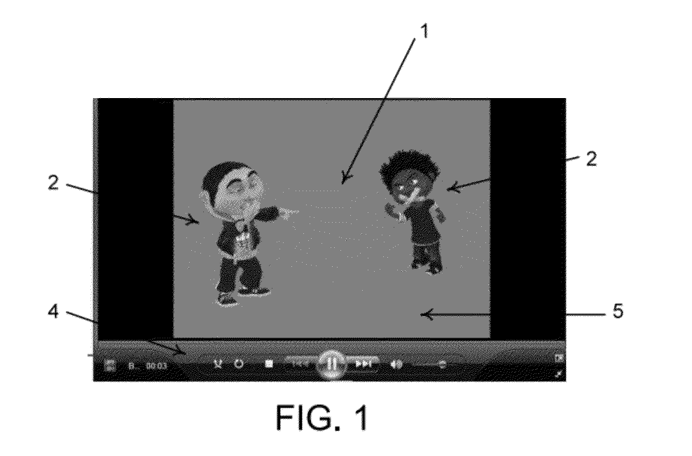

As illustrated in FIG. 1, the disclosed system and method enables virtual social interactions 1 for digital representations 2 through the use of dedicated virtual objects 3 (not shown). A digital representation may be a three-dimensional avatar or a two-dimensional image. The representation may include a cartoon caricature, a photograph or a realistic computer graphic representation, and may be animated or static. Such a digital representation may be rendered in a user interface 4 of a network service 5 including, but not limited to, a virtual world (such as Second Life), a social network service (such as Facebook), an online game (such as World of Warcraft), an Internet webpage, a text message service (such as SMS or MMS), an instant messaging (IM) service (such as MSN or Google Talk), an online blog, an online posting service (such as Twitter), or a Web 2.0 application.

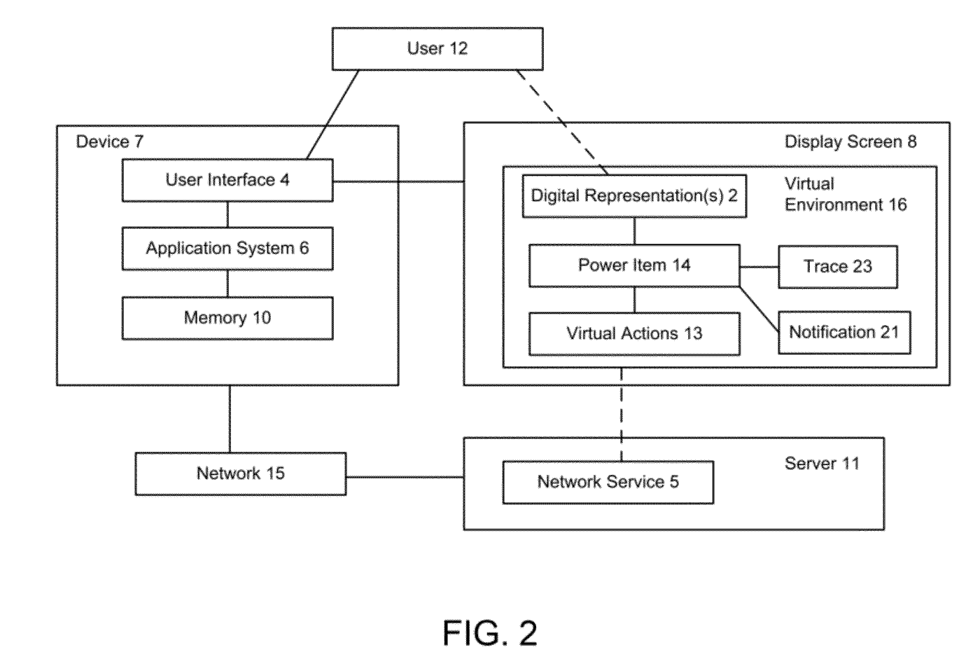

FIG. 2 illustrates an embodiment having a dedicated virtual object 3 generated by a software or hardware program/application system 6 on a device 7, such a laptop, computer, game console, smart phone or personal digital assistant (PDA). Computer readable instructions from the application system 6 may initiate the virtual object 3 that may be rendered via the user interface 4 for the network service 5 on a display screen 8 for the device 7. The network service 5 may include various paradigms, including web paradigms, 3D game paradigms, mobile service paradigms, and augmented reality paradigms. The display screen 8 may be part of a separate device, such as a television or a computer monitor.

The virtual object 3 may be stored in a memory medium 10, such as computer readable storage medium, located in the device 7 or on a server 11 associated with the network service 5. The memory medium 10 may be accessible by the device 7 and/or the server 11. Additionally, the display screen 8 may be accessible by the device 7 and/or the server 11.

A digital representation 2 may be associated with a real-life user or player 12 of the network service 5. The dedicated virtual object 3 is associated with one or more predetermined virtual actions 13 expressed by the digital representation 2 in the network service 5. The dedicated virtual object 3 may be a power item 14 that may be transferred from one digital representation 2 to another digital representation 2.

Power items 14 may be given as gifts from one digital representation 2 to another digital representation 2 or from the network service 5 to a digital representation 2. Power items 14 may also be purchased with virtual currency, credit cards, gift cards, currency-like options, third-party payment platforms (such as SMS or PayPal), loyalty rewards or points, or through premium rate phone numbers. Power items 14 may be transferred to a digital representation 2 on a special occasion such as a birthday or on Valentine's day from other digital representations 2 associated with users 12 such as friends, community managers, forum/mailing list administrators, or business partners.

A power item 14 may be received from the server 11 via a network 15 connected to the network service 5. A power item 14 may provide the digital representation 2 with a predetermined power, ability, tool, information, value, feature, characteristic or personality.

The transfer of a power item 14 may be based on a transaction or sale between digital representations 2. Branded or non-branded power items 14 may be transferred to a digital representation 2 on behalf of a business partner, advertiser, or sponsor. In addition, the power item 14 may be transferred by winning it during an online game or sharing it among digital representations 2. The transfer may be based on virtual social interactions 1 between digital representations 2. In an embodiment, a power item 14 may won by a digital representation 2 from another digital representation 2. The second digital representation 2 may represent a second real-life user or player 12 of a network service.

In addition, the transfer may be based on the virtual environment 16 of the network service 5. For example, the transfer may be based on a virtual interaction between the digital representation 2 and a virtual item, such as a sought-after hidden treasure, in the virtual environment 16 of the network service 5. In another example, the power item 14 may be transferred to the digital representation 2 upon reaching or entering a predetermined virtual environment 16, such as a certain room, phase, or level in the network service 5. A power item 14 may be given to or made available for purchase by a digital representation 2 when it joins a virtual social event in a virtual room. For example, digital representations 2 that attend a virtual fairy ball can purchase a magic wand power item 14. In an embodiment, a single user 12 or group of users 12 could propose a single power item 14 or collection of power items 14 to a single user 12 or a group of users 12 who join their room or event.

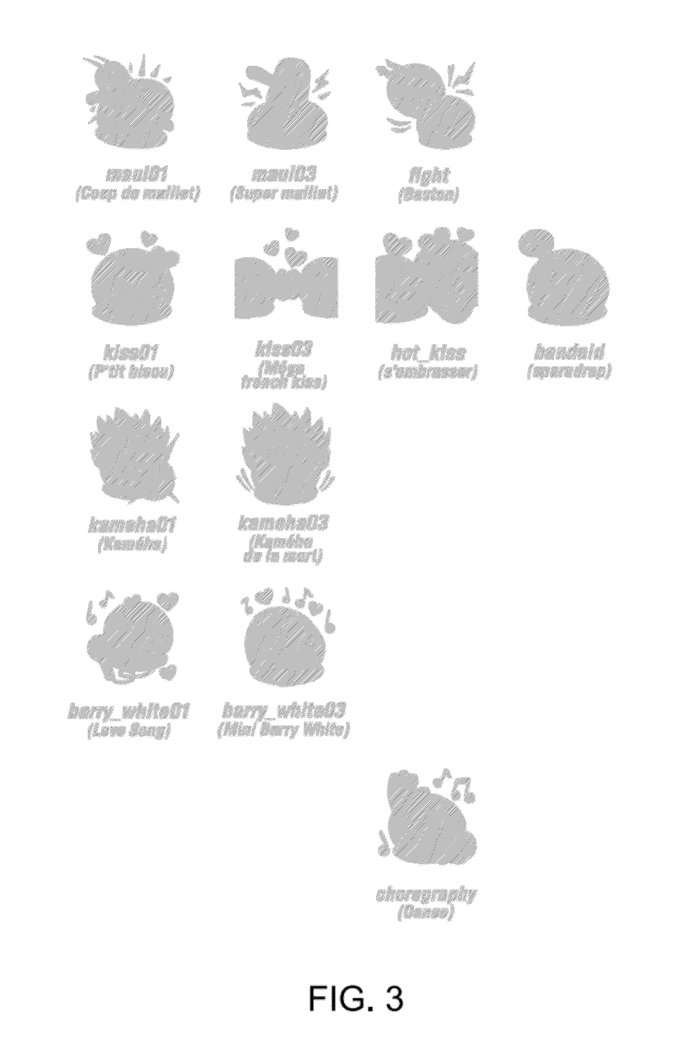

In an embodiment, a user 12 may select a power item 14. For example, a user 12 may click on an icon associated with the power item 14. The power item 14 may be activated by computer readable instructions to associate the power item 14 with a digital representation 2. The power item 14 need not be associated with a digital representation 2. The instructions may be based on a determination initiated by a user or automatically made as the result of a transfer, as described above. When a power item 14 is transferred to a digital representation 2, the power item 14 may be automatically activated for that digital representation 2. The power item 14 can be associated with an icon in a user interface 4 of a network service 5, as shown in FIG. 3. The user interface 4 may be a graphical user interface (GUI) displayed on the display screen 8 of the device 7.

The power item 14 may be triggered and the initial representation 17 of a digital representation 2 may be transformed into a different subsequent representation 18 such that the predetermined virtual actions 13 of the power item 14 are expressed via the display screen 8. The difference between the initial representation 17 and the subsequent representation 18 may be aural or visual, including graphics or text, in nature such that the user is on notice that the transformation of the digital representation 2 has occurred. The transformation may be a virtual state of mind transformation, a virtual feeling transformation, a virtual opinion transformation, or a virtual social pattern in progress transformation.

In an embodiment, a set of one or more digital representations 2 are transformed based upon a power item 14. The set of digital representations 2 may be representations of one or more users 12 in a network service 5.

The subsequent transformed representation 18 of a digital representation 2 may be associated with the predetermined virtual actions 13. The expression of the predetermined virtual actions 13 of the power item 14 may be visual and/or aural in nature. Such an expression may include a virtual action 19. This virtual action 19 may be an action taken by the digital representation 2 in the network service 5. The virtual action 19 may be an action impacting another digital representation 2 and/or the first digital representation 2 itself. The virtual action 19 may impact the virtual environment 16 of the network service 5. Examples of virtual expressions of the predetermined virtual actions 13 of a power item 14 are provided below in detail.

The triggering of the power item 14 may based on a virtual social interaction 1 between digital representations 2. A power item 14 may also be triggered based on the virtual environment 16 of the network service 5. For example, triggering a power item 14 when the digital representation 2 reaches or enters a predetermined virtual environment 16, such as a certain room, phase, or level in the network service 5. Hence, the triggering of the power item 14 may be determined by the user as represented by the digital representation 2.

Because the subsequent transformed representation 18 of a digital representation 2 may be associated with particular predetermined virtual actions 13, the subsequent representation 18 may be rendered and the predetermined virtual actions 13 of the power item 14 may be expressed upon triggering the power item 14. In an embodiment, the power item 14 may be triggered only a predetermined number of instances. Such power items 14 that may be triggered only limited number of times can be considered to be a consumable or limited-resource. In an embodiment, the power item 14 may be triggered in a predetermined set of situations, which may depend on contextual information.

The transformation of the initial representation 17 of a digital representation 2 into a subsequent representation 18 of the digital representation may be based upon a virtual action 19. Accordingly, the virtual action 19 resulting from the expression of the predetermined virtual actions 13 of the power item 14 may be based on a previous virtual action 19. Further, a virtual action 19 may be a virtual social interaction 1 between a first digital representation 2 and a second digital representation 2. As such, a virtual social interaction 1 may be a reaction to a past virtual social interaction 1. The predetermined virtual actions 13 may have predetermined social meanings.

The virtual action 19 may be based on contextual information 20 of the virtual social interaction 1 in the network service 5 or contextual information 20 of the virtual environment 16 in the network service 5. Such contextual information 20 may be the virtual social interaction 1 (such as a previous virtual action 19 between the digital representations 2), the virtual location or setting (such as a bar, library, home, work, or mall), a virtual social context or relationship between the digital representations 2 (such family member, friend, employer, enemy, colleague, or business party), or an user status or user state, as discussed below in detail and illustrated in FIG. 8. An user state may indicate the consequences of an utilized power item 14. For example, the act of knocking a digital representations 2 over its head may leave a non-visual tag indicating an user state.

Contextual information 20 may include any information or parameters existing in the network service 5. For example, the contextual information 20 may include a battle of the turntables if the virtual social interaction 1 was a DJ contest.

The predetermined virtual actions 13 may be associated to an In Real Life (IRL) situation or a shared In Virtual Life (IVL) meaning. In an embodiment, no pre-existing meaning may initially exist but a new meaning may be forged or created.

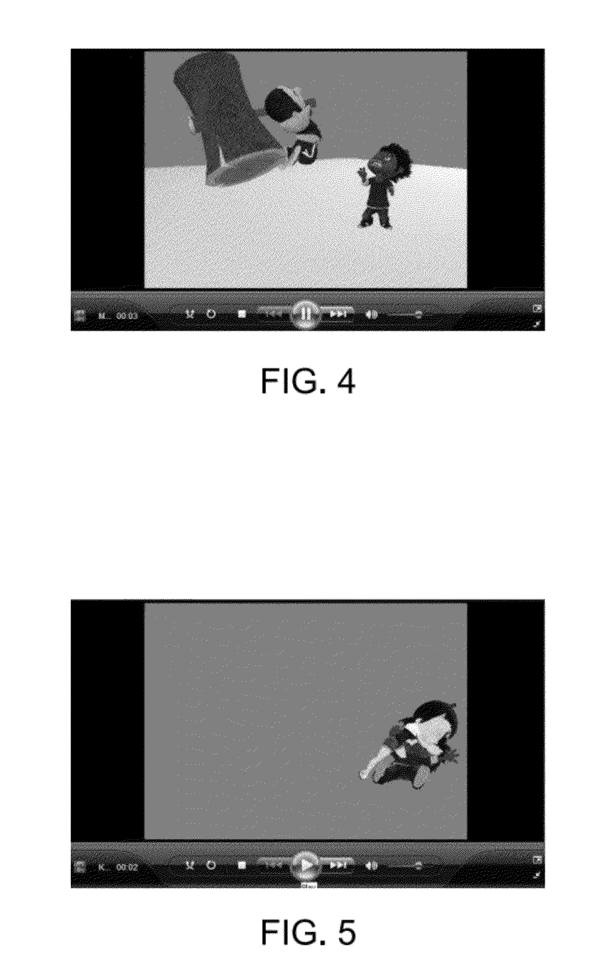

Referring back to FIG. 1, an avatar 2 is depicted as slapping a bandage over the mouth of another avatar 2. This may express the predetermined virtual actions that the first avatar wants the second avatar to stop talking. Similarly, FIG. 4 illustrates an avatar hitting another avatar over the head with a mallet when the first avatar is angry with the second avatar. FIG. 5 shows an avatar kissing another avatar. This expression by the first avatar may relate to the predetermined virtual actions associated with love.

In an embodiment, the expression of the predetermined virtual actions 13 may include a communication, such as a virtual message or notification 21, as further explained below. A virtual message 21 may be communicated from a first digital representation 2 to a second digital representation 2. The virtual message 21 may be written (such as text in a bubble) or spoken (such as audio played over speakers). The virtual message 21 may also be a virtual action 19 (such as a hand gesture from the first digital representation 2). A virtual message/notification 21 may include SMS messages, email messages, pop-ups on an IM service, a Facebook or Facebook-like service communication channels (such as feed posts, notifications, banner advertisements, event calendars, and future channels such as game notifications), a message sent to an electronic calendar, a posting to a blog, an ‘one through many to one’ channels such as a tweet, or a web advertisement banner. The real world communication channels may also be a billboard in the city of the user 12 associated with the first digital representation 2 or a poster at a club where the user 12 registered for an event.

In an embodiment, the expression of the predetermined virtual actions 13 is based on a virtual social interaction 1. For example, the predetermined virtual actions 13 may be associated with a set of social expressions 22. The social expression 22 rendered on the display screen 8 may be depend on a virtual social interaction 1 between digital representations 2.

The user 12 may select the second digital representation 2 and the power item 14. The power item 14 may be immediately triggered. The selection of a power item 14 may occur through a GUI menu in an inventory. It may include a context-specific menu associated with another user or a group of users. The triggering of the power item 14 may be executed immediately, with a timer, or may be not executed at all if some conditions are not met or if another user refuses.

The power items 14 may be iteratively customized/configured. For example, a power item 14 may be configured based on the contextual information 20. Customization of a power item 14 may be based on social tags or mode selectors. While the types of customizations may be on such input parameters, customizations may also be on output representations (such as user states/status, notifications, traces, transformed digital representations).

The expression of predetermined virtual actions 13 expressed by a first digital representation 2 may impact a second digital representation 2. An initial representation 17 of a second digital representation 2 may be transformed into a subsequent representation 18 of the second digital representation 2. The first digital representation 2 may or may not be transformed. Both digital representations 2 may be transformed, which can occur immediately in synchronization. In an embodiment, either the first digital representation 2 or the second digital representation 2 may be transformed. Also, the first digital representation 2 and a group of other digital representations 2 may be transformed.

In an embodiment, a trace 23 may be provided for the first digital representation 2 and/or the second digital representation 2. The trace 23 may be based upon a virtual action 19. The trace 23 may be a virtual result of a triggered power item 14 on a digital representation 2. The trace 23 may represent a status 24 of a digital representation 2. The status 24 may impact a virtual social interaction 1 of a digital representation 2 in the network service 5. The status 24 of the digital representation 2 may be a virtual state of mind, a virtual feeling, a virtual opinion, a virtual social pattern in progress, or an expression of a virtual social relationship. Accordingly, social patterns for a digital representation 2 may be changed.

A trace may be based on contextual information 20 as the contextual information 20 may determine whether a virtual social interaction 1 is offensive or not. In an embodiment, a trace 23 may be removed or blocked by a digital representation 2. Further, a network service 5 may enable the blocking of undesired, attempted transformations of digital representations 2 or the generation of virtual messages/notifications 21. In an embodiment, preconditions for transformations and generations may be included. After an triggering virtual action/event occurs, a receiving targeted digital representation 2 may be able to accept, reject, block, and/or remove targeted digital representation 2 transformations, traces 23 and messages/notifications 21.

As an example, a kiss between digital representations 2 that are friends are be socially accepted, and may even associate the trace having the social meaning of being in love. Contrary, a kiss may be offensive among certain digital representations 2 within specific social contexts, and the resulting trace 23 may represent a status of anger or contempt. Similarly, the setting or location provide the contextual information 20 may determine or affect a trace 23. For example, a punch within a virtual boxing ring or a martial arts dojo may be acceptable, and even highly valued, while the same punch may be offensive or illegal if committed on a virtual public street.

A trace 23 may also change the look and the feel of a digital representation 2. The trace 23 may be visually represented on the screen 8 by a mark 25 on a digital representation 2 in the network service 5. A trace 23 may also be displayed in a profile of a user 12 of the network service 5, or a network feed, or a virtual posting associated with the user 12. A trace 23 or a notification 21 may refer to a social meaning, for example: French kiss, LOL, etc.

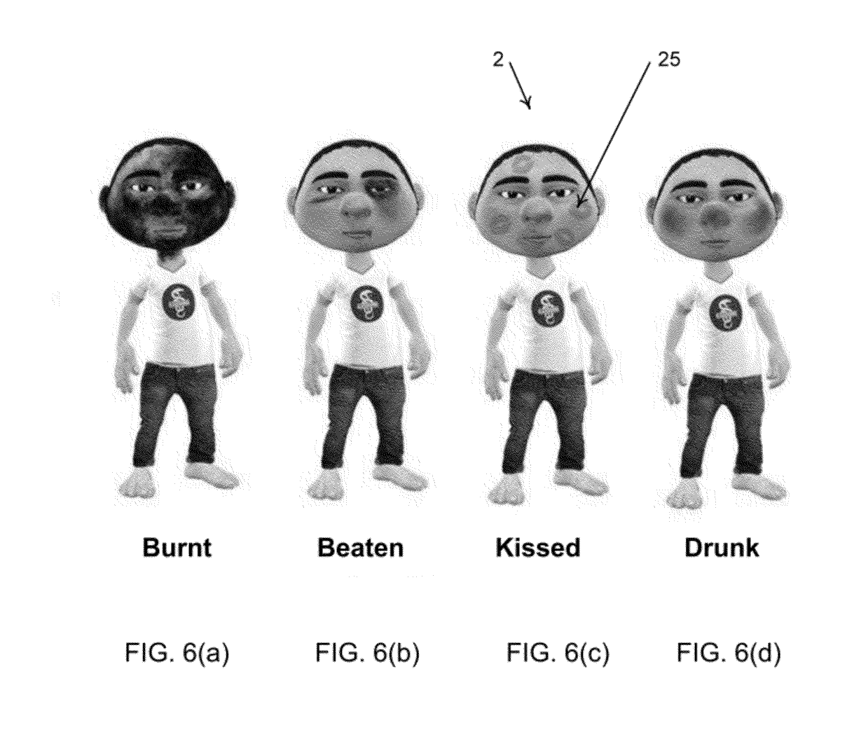

Various examples of marks 25 on an avatar are illustrated in FIGS. 6(a)-(d). For example, FIG. 6(c) shows kiss marks 25 on the face of an avatar 2 after the avatar was kissed by another avatar, as shown in FIG. 5. Marks 25 may include virtual representations of burns, bruises, cuts, black-eyes, bloodied or swollen lips. Such marks 25 may indicate that the a digital representation 2 was beaten, bruised or burnt in the network service 5. Other marks 25 may include redness of eyes, nose or checks to indicate a drunken status of a digital representation 2. It will be apparent to one of skill in the art that almost infinite variations of virtual physical features are possible to be represented by such marks 25 depending upon the characteristics of the desired status or mood for a digital representation 2.

Triggering a power item 14 may spawn new digital representations 2, traces 23, notifications or virtual messages 21. A new fan page on FaceBook may also be generated as a result. As a power item 14 is triggered, one or more of the digital representations 2 may transform. In addition, optional digital representations 2 may be spawned/created and notifications or virtual messages 21 may be sent.

In an embodiment, various digital representation 2, traces 23 may appear upon triggering of a power item 14. For example, when a Barry White power item 14 is triggered, a Barry White digital representation 2 may appear between two digital representations 2. The Barry White digital representation 2 may sing them a romantic song.

In an embodiment, various notifications or virtual messages 21 may be sent. As an example, a mallet power item 14 is triggered and a GUI animated text “Move it!” could appear over an digital representation 2 before fading out. The text may be chosen by a user 12. When a kiss power item 14 is triggered by a boy digital representation 2 on a girl digital representation 2, a notification could appear on the boy's FaceBook wall, such as “Bob just kissed Melissa at the Big Party event.” When a Kameha power item 14 is triggered by a girl digital representation 2 on a boy digital representation 2, a notification could appear on the girl's actions-of-today cloud of her profile page on a website which lists daily Kameha actions, and a rollover text list with a text chosen by the first user, such as “Melissa destroyed Bob,” may be included in the list.

In an embodiment, power items aim to make tangible and facilitate social actions and interactions of social web and mobile services users. Common network services include social networks, virtual worlds, Massively Multiplayer Online Role-Playing Games (MMORPGs), and all services involving a dynamically evolving digital representation of one self. As explained above, power items may be represented as a virtual object, and can be acquired, sold, used, stored and/or stocked. A power item may be activated by a user onto him/herself or onto another user. Power items may have a visual impact on the digital representation of its users. Power items change the initial state of the digital representation of the users into different ones depending of the social connections between the users interacting with one another and the context of the interaction. Power items may leverage the dynamically evolving digital representation of the user to establish a innovative communication framework, enriching social interactions.

A power item may be a virtual item associated with a digital representation of the users involved in a specific social transaction. A power item may incarnate a specific social meaning as established by a service operator or by a user. As the social meaning is connected to an IRL situation or a shared IVL meaning, it may be triggered to express this meaning at the moment the person using it considers appropriate. An icon can be associated to a power item to allow its use in a web or mobile GUI. In an embodiment, a power item can be used a limited number of times, and hence has an added value.

To be triggered in an embodiment, a power item may connect the person using it with at least one other person, either in real time or asynchronously. Once used, the power item may have a visible impact or trace on the digital representation of the user and on the other users involved in the power item action. A power item trace may then materialize in a social network feed or on public web posts connected to the user. The trace can thereafter represent a state of mind, a feeling or an opinion or a social pattern in progress.

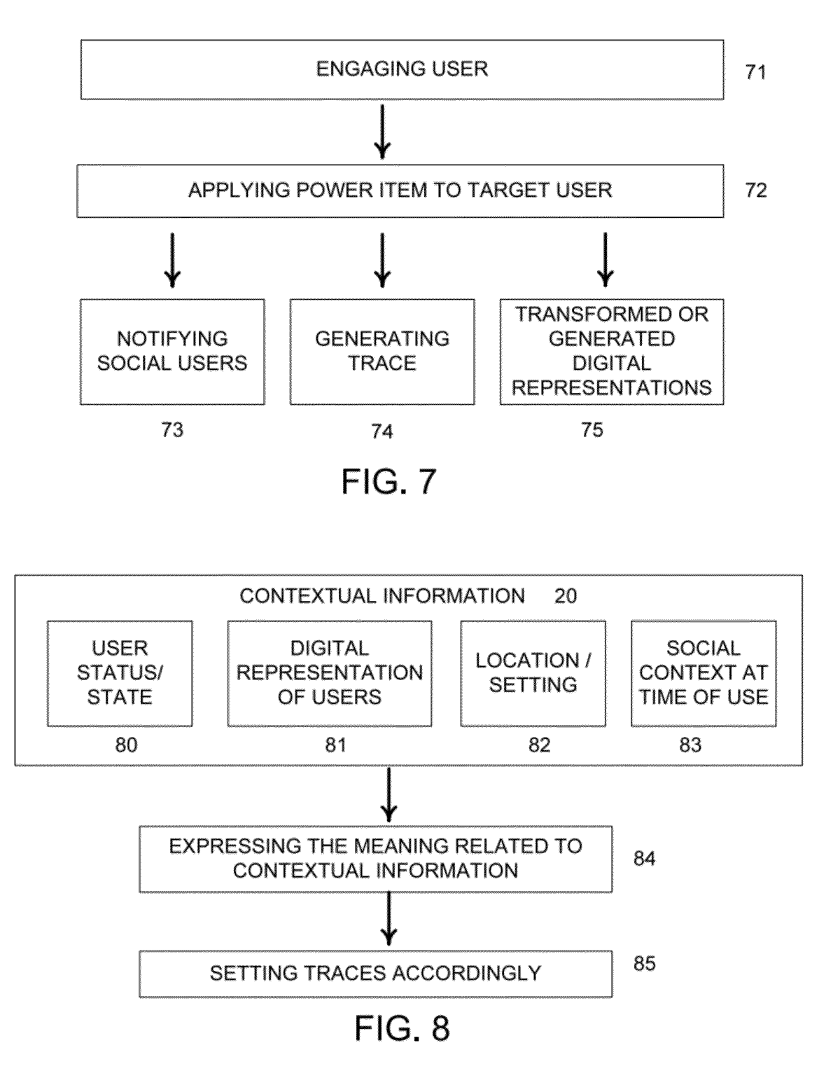

As shown in an embodiment depicted by FIG. 7, a digital representation in a user engaging process 71 may apply 72 a power item to a targeted user. Consequentially, notification 73 of the social action is provided to the user's social connections, feed and profile. In addition, visible traces are generated 74 and marks are displayed on the digital representation. Further, digital representations are transformed and/or generated 75. FIG. 8 illustrates that the contextual information 20 includes user status and/or state 80, the digital representation of users 81, the location and setting 82, and the social context at the time of use 83. The specific expression of the predetermined virtual actions can be related 84 to the contextual information 20. Further, the trace is set accordingly 85.

In an embodiment, power items 14 may be applied in virtual worlds as virtual social actions. Such a power item 14 may allow an avatar in a certain state to socially interact with another avatar in accordance with a specific virtual social context 27 of a virtual world. A virtual context 27 may be forged out of the following elements: the location in which the social interaction occurs; the state of the user's avatar; the state of the other avatars, and particularly the avatar that the power item 14 will be applied to; or the social connections between the users 12. The social interactions may particularly relate to whether the users 12 are virtually connected (such as Facebook friends or virtual world friends), and/or whether the users 12 know each other in real life.

The various combination/accumulation of power items 14 associated with a digital representation 2 in a virtual context 27 eventually create social patterns 28 out of which emerges a social paradigm 29 that will forge a reference and pact between users 12 to develop rich life stories 30 between themselves. These stories 30 can be encouraged by the virtual context 27 as a reference to the accepted social paradigm 29 between users 12 which are linked to IRL settings or IVL conventions, which are presented/discussed and accepted between users 12. For example, on a football field, people play football by rules known by all participants. In a restaurant example, people dressed up in certain attire may be waiters, the door in the back accesses the kitchen, and the way the waiter engages a conversion with the clients is set.

These stories 30 can also be engaged by activities 31. Activities 31 are social games applying Plato's principle “you can discover more about a person in a day of play than in a year of conversation.” What this means is that, although games have rules and points/ranking, the key aim of games is to allow engaging social interactions to happen with people you care for, such as old friends or new friends sharing your social patterns. Such games are structured around power items 14 and chatting between the users 12.

As a benefit of the power item 14/virtual context 27 dynamic, users 12 will create live stories 30 bottom up, as opposed to the top down approach of MMORPGs. In MMORPGs, the social paradigm 29 and the way the avatars look like and are expected to behave is linked to the designer's vision. In contrast, the power items 14/virtual context 27 allows the users 12 to have a dynamic way to create engaging shared stories 30 with whatever avatar they see fit to their intention. The avatar is transformed into a new social communication means to enable a social frame built.

In an embodiment, the network service may be a Freemium service. As with power items used to customize a user's avatar, power items 14 may be purchased. Such purchases can be done using loyalty rewards points/currency 32, such as frequent flyer mileage, Microsoft points, etc., that are earned and/or awarded simply by using the network service. Some power items 14 can only be bought with credits 33, such as virtual currency. In certain embodiments, power items 14 may not be traded. Further, it may be required that certain power items 14 must be used in a designated virtual context 27 chosen by power users 12.

Embodiments of the disclosed system and method may involve various components of a computer system. The particular architecture or manner of interconnecting the components may vary. Certain systems may have fewer or more components. In an embodiment, a system may implement a central server and terminals/clients. Other configurations are possible, as will be readily apparent to those skilled in the art.

A system may include an inter-connect (e.g., bus and system core logic), which interconnects a microprocessor(s) and memory. The microprocessor may be coupled to cache memory. The inter-connect may interconnect the microprocessor(s) and the memory together and also interconnects them to a display controller and display device and to peripheral devices such as input/output (I/O) devices through an input/output controller(s). Typical I/O devices include mice, keyboards, modems, network interfaces, printers, scanners, video cameras and other devices which are well known in the art.

The inter-connect may include one or more buses connected to one another through various bridges, controllers and/or adapters. In an embodiment the I/O controller includes a USB (Universal Serial Bus) adapter for controlling USB peripherals, and/or an IEEE-1394 bus adapter for controlling IEEE-1394 peripherals.

The memory may include ROM (Read Only Memory), and volatile RAM (Random Access Memory) and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In an embodiment, the central servers may be implemented using one or more data processing systems. In some embodiments, one or more servers of the system may be replaced with the service of a peer to peer network or a cloud configuration of a plurality of data processing systems, or a network of distributed computing systems. The peer to peer network, or cloud based server system, can be collectively viewed as a server data processing system.

Embodiments of the disclosure can be implemented via the microprocessor(s) and/or the memory. For example, the functionalities described above can be partially implemented via hardware logic in the microprocessor(s) and partially using the instructions stored in the memory. Some embodiments are implemented using the microprocessor(s) without additional instructions stored in the memory. Some embodiments are implemented using the instructions stored in the memory for execution by one or more general purpose microprocessor(s). Thus, the disclosure is not limited to a specific configuration of hardware and/or software.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions referred to as computer programs. Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A computer readable storage medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

While the invention has been particularly shown and described with reference to a embodiment thereof, it will be understood by those skilled in the art that various changes in form and details may be made therein without departing from the spirit and scope of the invention.

1. A method for providing social interactions for digital representations, comprising the steps:
receiving a power item via a network, wherein the power item is a virtual object, wherein the power item is associated with one or more predetermined virtual actions;
storing the power item in a memory medium, wherein the memory medium is accessible to a computing device;
triggering the power item by a first digital representation, wherein the first digital representation is displayed on a screen, wherein the first digital representation is a representation of a first user in a network service; and,
transforming at least one digital representation based upon the power item, wherein the at least one transformed digital representation comprises a second digital representation, wherein the second digital representation is a representation of a second user in the network service.

2. The method of claim 1, further comprising:
establishing a virtual social interaction between the first digital representation and the second digital representation based upon the power item.

3. The method of claim 2, wherein the virtual social interaction is based on contextual information in the network service.

4. The method of claim 3, wherein the contextual information is selected from a group consisting of the following: an user status; an user state; a virtual social interaction between a plurality of digital representations in the network service; a virtual location or setting in the network service; or a virtual social context or relationship between a plurality of digital representations in the network service.

5. The method of claim 1, wherein the transformed second digital representation is associated with a predetermined virtual action.

6. The method of claim 5, wherein expression of the predetermined virtual action is based on a virtual social interaction.

7. The method of claim 5, wherein the predetermined virtual action is associate with an In Real Life (IRL) situation or a shared In Virtual Life (IVL) meaning.

8. The method of claim 5, further comprising:
generating a social meaning, wherein the predetermined virtual action is associate with the social meaning.

9. The method of claim 1, wherein the step of triggering the power item is determined by the first user.

10. The method of claim 1, wherein the power item is configured by a social tag.

11. The method of claim 1, wherein the power item is associated with an icon in a graphical user interface (GUI) displayed on the screen.

12. The method of claim 1, wherein the computing device is a smart phone or a personal digital assistant (PDA).

13. The method of claim 1, wherein the computing device is a computer.

14. The method of claim 1, wherein the power item is triggered a predetermined number of times.

15. The method of claim 1, wherein the power item is triggered in a predetermined set of virtual situations.

16. The method of claim 1, further comprising:
transferring the power item to a digital representation.

17. The method of claim 1, wherein the transferring of the power item is based on a transfer selected from a group consisting of the following: a gift; a purchase using real currency; a purchase using gift cards; a purchase using currency-like options; a purchase using third-party payment platforms; a purchase using virtual currency; a purchase using loyalty rewards or points, or a winning through a contest.

18. The method of claim 1, wherein the transferring of the power item is based on a predetermined event selected from a group consisting of the following: a holiday, a birthday, or a special occasion.

19. The method of claim 1, further comprising:
communicating a virtual message from the first digital representation to the second digital representation in the network service based upon a virtual social interaction.

20. The method of claim 1, further comprising:
transforming the first digital representation based upon the power item.

21. The method of claim 1, wherein the transformation of the first digital representation or the second digital representation is a transformation selected from a group consisting of the following: a visual transformation, a graphical transformation, an aural transformation, a virtual state of mind transformation, a virtual feeling transformation, a virtual opinion transformation, a virtual social pattern in progress transformation, or an expression of a virtual social relationship.

22. The method of claim 1, further comprising:
providing a trace for the first digital representation or the second digital representation, wherein the trace is based upon the power item.

23. The method of claim 22, wherein the trace represents a status of the first digital representation or the second digital representation, wherein the status impacts a virtual social interaction.

24. The method of claim 23, wherein the status of the first digital representation or the second digital representation is selected from a group consisting of the following: a virtual state of mind, a virtual feeling, a virtual opinion, or a virtual social pattern in progress.

25. The method of claim 22, wherein the trace is visually represented on the screen by a mark on the first digital representation or the second digital representation in the network service.

26. The method of claim 25, wherein the mark is selected from a group consisting of the following: a kiss mark, a burn mark, a bruise mark, a cut mark, a beaten mark, or a drunk mark.

27. The method of claim 22, wherein the trace is expressed in a display selected from a group consisting of the following: a profile, a network feed, a virtual posting, a twitter feed, a blog post, a Web 2.0 application, a SMS text message, a MMS text message, a web advertisement banner, Facebook or Facebook-like service communication channels, and real world communication channels.

28. The method of claim 22, wherein the trace is further based upon a virtual social interaction.

29. The method of claim 28, wherein the trace is further based on contextual information in the network service.

30. The method of claim 22, further comprising:
removing or blocking the trace from being associated with the first digital representation or the second digital representation.

31. The method of claim 1, wherein the first digital representation or the second digital representation is a representation selected from a group consisting of the following: a two-dimensional (2D) image; a three-dimensional (3D) image; a realistic computer graphic representation; an avatar; a static representation; or an animated representation.

32. The method of claim 1, wherein the network service is a service selected from a group consisting of the following: a virtual world; a social network service; an online game; an Internet webpage; a text message service; an instant messaging service; an online blog; or an online posting service.

33. The method of claim 1, further comprising:
expressing the one or more predetermined virtual actions, wherein the one or more predetermined virtual actions are expressed visually or aurally.

34. The method of claim 1, further comprising:
establishing social patterns between the first digital representation and the second digital representation based on a plurality of virtual social interactions, wherein the plurality of virtual social interactions are based on a plurality of power items.

35. The method of claim 34, further comprising:
developing virtual stories between the first digital representation and the second digital representation based on the social patterns.

36. The method of claim 1, further comprising:
selecting the power item; and,
activating the power item, whereby the power item becomes associated with a first digital representation.

37. The method of claim 36, wherein the step of selecting the power item comprises clicking on an icon associated with the power item.

38. The method of claim 1, further comprising:
selecting the second digital representation; wherein the step of selecting the second digital representation is determined by the first user.

39. The method of claim 1, wherein the at least one transformed digital representation comprises a set of transformed digital representations.

40. The method of claim 1, wherein the at least one transformed digital representation comprises only a single transformed digital representation, wherein the single transformed digital representation is the second digital representation.

41. The method of claim 1, wherein the first user and the second user are the same user.

42. The method of claim 1, wherein the first user and the second user are different users.

43. The method of claim 1, further comprising:
generating a spawned digital representation; wherein the spawned digital representation results from the step of triggering the power item.

44. The method of claim 1, further comprising:
transmitting a notification based on the power item.

45. The method of claim 1, further comprising:
customizing the power item.

46. The method of claim 45, wherein the customized power item is based on contextual information.

47. A method for providing social interactions for digital representations, comprising the steps:
triggering a power item, wherein the power item is a virtual object, wherein the power item is associated with one or more predetermined virtual actions, wherein the power item is associated with a first digital representation, wherein the first digital representation is a representation of a first user in a network service, wherein the first digital representation is displayed on a screen, wherein the screen is accessible to a computing device;
transforming a second digital representation based upon the power item and a virtual social interaction, wherein the second digital representation is a representation of a second user in the network service, wherein the virtual social interaction is between the first digital representation and the second digital representation, wherein the virtual social interaction is further based on contextual information in the network service; and,
establishing a trace for the second digital representation, wherein the trace is based upon the power item.

48. The method of claim 47, further comprising:
transforming the first digital representation based upon the power item; and
establishing the trace for the first digital representation.

49. The method of claim 20, wherein the transformation of the first digital representation or the second digital representation is a transformation selected from a group consisting of the following: a visual transformation, a graphical transformation, an aural transformation, a virtual state of mind transformation, a virtual feeling transformation, a virtual opinion transformation, a virtual social pattern in progress transformation, or an expression of a virtual social relationship.
